(19) United States
(12) Patent Application Publication
(10) Pub. No.: US 2021/0176962 A1
(43) Pub. Date: Jun. 17, 2021

(54) COMMUNICATION AND GUIDANCE SYSTEM

(71) Applicant: Trechrein LLC, St. Louis, MO (US)

(72) Inventor: Antonio J Gates, st. Louis, MO (US)

(73) Assignee: Trechrein LLC, St. louis, MO (US)

(21) Appl. No.: 17/123,113

(22) Filed: Dec. 16, 2020

Related U.S. Application Data
(60) Provisional application No. 62/948,461, filed on Dec. 16, 2019.

(51) Int. Cl. A01K 15/02; A01K 27/00; A01K 11/00; A41D 1/00

(52) U.S. Cl. CPC A01K 15/02; A01K 27/002; H04W 4/80; A01K 27/006; A41D 1/002; A01K 11/008

(57) ABSTRACT

The present disclosure relates to a communication and guidance system wherein multiple devices are integrated and linked for faster, efficient, and unique systems, apparatus, manufacture, and methods thereof. These facilitate communication and guidance systems between various devices, wearables, non-wearables, and others that enable and promote integration and communication between animals, humans, and any combination thereof. The communication and guidance system be direct, indirect, manual, automatic, and/or improved by artificial intelligence.

### CROSS-REFERENCE TO RELATED APPLICATIONS

This application is a Non-Provisional application claiming priority of the Provisional U.S. Application No. 62/948,461 filed on Dec. 17, 2019, and is incorporated in entirety herein. This application is a continuation-in-part of the non-provisional application Ser. No. 16/935,067 with the priority of Jul. 23, 2019, and is incorporated in entirety herein by reference.

### STATEMENT REGARDING FEDERALLY SPONSORED RESEARCH OR DEVELOPMENT

Not application.

The present disclosure relates to a communication and guidance system wherein multiple devices are integrated and linked for faster, efficient, and unique systems, apparatus, and methods thereof.

### BACKGROUND

There are no communication and guidance systems, methods, and devices that facilitate integration and communication between devices on animals and humans. This invention provides a communication and guidance integration system, method, and devices for humans and animals.

### BRIEF DESCRIPTION OF THE INVENTION

This application relates to a communication system between a multitude of devices, including wearables and non-wearables devices. Both wearables and non-wearables may be smart and incorporated with other electrical, electronics, microelectronics, nanoelectronics, internet of things, Bluetooth, wireless, micro-wireless, computer systems, etc., and any combination thereof. The communication may be wireless, wired, or a combination of both. Furthermore, the communication may be regulated and operated via touch-sensitive technologies, voice command technologies, integrated smartphones, wired or wireless a remote-control, or any combination thereof. The communicating device(s) may be weather-, water-, temperature-, humidity-resistance or -proof, or any combination thereof. The device batteries may be rechargeable, or not rechargeable and may recharge via various modes such as, but not limited to, wired, wireless, solar, or any combination thereof.

In an embodiment of the invention, the non-wearable(s) may contain micro-GPS, GPS/SOS, or another tracking device. The tracking device may track via GPS, satellite, sound, and light (visual) signals.

The communication device may contain one or more components, e.g., electronic, electrical, smart, computerized, speaker, microphone, cellular phone, camera, electrical lights or streaks of one or more colors, LED bulbs, flashlight, a lantern, USB port, micro-USB port, vibrating modules, sound generating devices, vehicles or vehicle parts, recharging ports, recharging devices, kill switches, artificial intelligence hardware or software, etc., or any combination thereof. The lights may have different strobing modes and intensity levels, color modes, light brightness, intensity modes, or any combination thereof. The devices may integrate with a software application (app/APP).

### BRIEF DESCRIPTION OF DRAWINGS

FIG. 1: An aspect of the dog wearable device.

FIG. 2: An aspect of the wearable device showing technologies containing pouch.

FIG. 3: An aspect of the device worn by a dog.

FIG. 4: An aspect of the wearable device showing technologies containing pouch on a dog.

FIG. 5: An aspect of the wearable device worn by a human.

FIG. 6: Integration of wearables, non-wearables for human and non-human animal users.

### DETAILED DESCRIPTION OF THE INVENTION

Examples embodiments are provided so that this disclosure will be thorough and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components but do not preclude the presence or addition of one or more other features, integers, steps, operations, elements, components, and/or groups thereof. The method steps, processes, and operations described herein are not to be construed as necessarily requiring their performance in the particular order discussed or illustrated unless specifically identified as an order of performance. It is also to be understood that additional or alternative steps may be employed.

Although the terms first, second, third, etc., may be used herein to describe various elements, components, regions, layers and/or sections, these elements, components, regions, layers and/or sections should not be limited by these terms. These terms may be only used to distinguish one element, component, region, layer, or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The preceding summary, as well as the following detailed description of certain embodiments, will be better understood when read in conjunction with the appended figure of experimental data and results. As used herein, an element or step recited in the singular and proceeded with the word “a” or “an” should be understood as not excluding the plural of said elements or steps unless such exclusion is explicitly stated. Furthermore, references to “one embodiment” or “an embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property. When a definition is provided herein, it supersedes any other meaning or definition.

Communication and/or guidance may be between humans, or animals, or between humans and animals.

As used herein, the term “wearable” means that which can be directly or indirectly connected, attached, placed into, onto a human or an animal, or maybe worn by a human or an animal.

As used herein, the term “strip” means a linear material.

As used herein, the term “streak” means a linear material with a width smaller or thinner than the strip mentioned above.

This application relates to a unique and novel system, apparatus, and method for communication between humans and/or between humans and animals. The invention further provides a guidance system, wherein humans may guide animals and vice versa; humans and animals may guide each-other, humans, and animals, respectively. These communication and guidance systems, methods, and apparatus are achievable using one or more human and animal senses such as vision, touch, voice, hearing, smell, and taste. The communication and guidance may include uni-, bi-, multiple directional, and/or any combination thereof. Furthermore, this invention's communication and guidance system may use wearable and/or non-wearable apparatus and devices. The wearables and non-wearables may incorporate electrical devices, electronics, microelectronics, nanoelectronics, smart, Bluetooth, wireless, micro-wireless, internet, internet of things, computer systems, micro-computers, artificial intelligence components, and data, etc., and any combination thereof.

In an embodiment of the invention, the non-wearable(s) communication may be via a wire.

In an embodiment of the invention, the non-wearable(s) communication may be wireless.

In an embodiment of the invention, the non-wearable(s) may communicate via wire to a controller.

In an embodiment of the invention, the non-wearable(s) may wirelessly communicate with a controller.

In an embodiment of the invention, the non-wearable(s) communication may operate or regulate via touch-sensitive technology.

In an embodiment of the invention, the non-wearable(s) communication may operate or regulate via voice command technology.

In an embodiment of the invention, the non-wearable(s) communication may happen via the cellular smartphone, wherein the non-wearable may integrate with a smartphone.

In an embodiment of the invention, the non-wearable(s) may communicate and operate and regulate via a wired remote, wireless remote, and/or both remote-controls.

In an embodiment of the invention, the non-wearable(s) batteries may recharge via wired, wireless, solar, and/or any combination thereof.

In an embodiment of the invention, the non-wearable(s) contains micro-GPS/SOS and/or another tracking device. The tracking device may track via micro-GPS/SOS, sound, and light (visual) signals.

In an embodiment of the invention, the non-wearable(s) may be weather-, water-, temperature-, humidity-resistance, and/or any combination thereof.

In an embodiment of the invention, the non-wearable(s) may be weather-, water-, temperature-, humidity-proof, and/or any combination thereof.

In an embodiment of the invention, the non-wearable(s) may contain one or more of a speaker, microphone, the cellular phone, the camera, electrical lights streaks of one or more colors, LED bulbs, flashlight, lantern, vibrating modules, sound generating devices, recharging ports, vehicles, vehicle parts (e.g., staring-wheel, handle-bar, brakes, lights, electronic systems, electrical systems, sensors, floor components car seat, powertrain and chassis, braking system, electrified powertrain components, engine components, engine cooling system, engine oil systems, headlights, bumper cover, car fender, radiator support, catalytic converter, car mirror, car hood, step bumper, lower control arm, tail light, window regulator, fuel pump replacement, car body and main part body components, including trim, bonnet/hood, bonnet/hood, bumper, unexposed bumper, exposed bumper, cowl screen; decklid, suspension and steering systems, transmission system, air conditioning system, bearings, hose, charging docks, etc.), 2-10, 2, 4, 6, 8, 10 wheeled vehicles, artificial intelligence hardware, software, training data, collected data, etc., or any combination thereof. The camera may rotate from 0-360, e.g., 0-45, 0-90, 0-135, 0-180, 0-225, 0-280, 0-360, and the camera may extend from 0-5 feet, e.g., 0-1, 0-2, 0-3, 0-4, 0-5 feet.

In an embodiment of the invention, the non-wearable(s) may have one or more micro-USB or a USB port(s).

In an embodiment of the invention, the non-wearable(s) may contain one or more strobe light mode, light color modes, light brightness modes, or any combination thereof.

In an embodiment of the invention, the non-wearable(s) may have one or more kill switch to conserve battery charge. The kill switch turns off the device such that no energy leaks during off or rest mode.

In an embodiment of the invention, the non-wearable(s) may include electronic, electrical, computerized, micro-computerized, smart, etc. such as a speaker, microphone, the cellular phone, the camera, electrical lights streaks of one or more colors, LED bulbs, flashlight, a lantern, USB port, micro-USB port, vibrating modules, sound generation device, vehicles, vehicle parts (e.g., staring-wheel, handle-bar, brakes, lights, electronic systems, electrical systems, sensors, floor components car seat, powertrain and chassis, braking system, electrified powertrain components, engine components, engine cooling system, engine oil systems, headlights, bumper cover, car fender, radiator support, catalytic converter, car mirror, car hood, step bumper, lower control arm, tail light, window regulator, fuel pump replacement, car body and main part body components, including trim, bonnet/hood, bonnet/hood, bumper, unexposed bumper, exposed bumper, cowl screen; decklid, suspension and steering systems, transmission system, air conditioning system, bearings, hose, charging docks, etc), 2-10, 2, 4, 6, 8, 10 wheeled vehicles, artificial intelligence components, recharging ports, etc., or any combination thereof. The recharging devices may be made of and/or covered with weather-resistant and/or weather-proof materials.

In an embodiment of the invention, the non-wearable(s) may integrate with a software app/APP.

The communication and guidance system provides for the integration of wearable devices. The wearable devices may be for humans and/or animals. They may communicate and guide with other wearable and/or non-wearable devices and systems.

In an embodiment of the invention, the wearable(s) communication may be via a wire.

In an embodiment of the invention, the wearable(s) communication may be wireless.

In an embodiment of the invention, the wearable(s) may communicate via wire to a controller.

In an embodiment of the invention, the wearable(s) may communicate wirelessly to a controller.

In an embodiment of the invention, the wearable(s) communication may be via touch-sensitive technology.

In an embodiment of the invention, the wearable(s) communication may occur via voice command technology.

In an embodiment of the invention, the wearable(s) communication may occur via the cellular phone, wherein the wearable may integrate with a smartphone.

In an embodiment of the invention, the wearable(s) communication may be via a wired, wireless remote control, and/or both remote controls.

In an embodiment of the invention, the wearable(s) batteries may recharge via wired, wireless, solar, and/or any combination thereof.

The wearable(s) may contain micro-GPS, GPS/SOS, or another tracking device in an embodiment of the invention. The tracking device may track via micro-GPS, GPS, sound, and light signals.

In an embodiment of the invention, the wearable(s) may be weather-, water-, temperature-, humidity-resistance, and/or any combination thereof.

In an embodiment of the invention, the wearable(s) may be weather-, water-, temperature-, humidity-proof, and/or any combination thereof.

The wearable(s) may contain one or more of a speaker, microphone, the cellular phone, the camera, electrical lights streaks of one or more colors, LED bulbs, flashlight, a lantern, vibrating modules, sound generation device, vehicles, vehicle parts (e.g., staring-wheel, handle-bar, brakes, lights, electronic systems, electrical systems, sensors, floor components car seat, powertrain and chassis, braking system, electrified powertrain components, engine components, engine cooling system, engine oil systems, headlights, bumper cover, car fender, radiator support, catalytic converter, car mirror, car hood, step bumper, lower control arm, tail light, window regulator, fuel pump replacement, car body and main part body components, including trim, bonnet/hood, bonnet/hood, bumper, unexposed bumper, exposed bumper, cowl screen; decklid, suspension and steering systems, transmission system, air conditioning system, bearings, hose, charging docks, etc.), 2-10, 2, 4, 6, 8, 10 wheeled vehicles, artificial intelligence components such as hardware, software, training data, collected data, etc., recharging ports, recharging devices, etc. in an embodiment of the invention. The camera may rotate from 0-360, e.g., 0-45, 0-90, 0-135, 0-180, 0-225, 0-280, 0-360 and may extend from 0-5 feet, e.g., 0-1, 0-2, 0-3, 0-4, 0-5 feet.

For safety, the wearable(s) may contain various strobe light mode, various light color modes, or variable light brightness, and/or any combination of these settings in an embodiment of the invention.

In an embodiment of the invention, the wearable(s) may include electronic, electrical, computerized, smart, etc. such as a speaker, microphone, the cellular phone, the camera, electrical lights streaks of one or more colors, LED bulbs, flashlight, a lantern, USB port, micro-USB port, vibrating modules, sound generation device, vehicles, vehicle parts (e.g., staring-wheel, handle-bar, brakes, lights, electronic systems, electrical systems, sensors, floor components car seat, powertrain and chassis, braking system, electrified powertrain components, engine components, engine cooling system, engine oil systems, headlights, bumper cover, car fender, radiator support, catalytic converter, car mirror, car hood, step bumper, lower control arm, tail light, window regulator, fuel pump replacement, car body and main part body components, including trim, bonnet/hood, bonnet/hood, bumper, unexposed bumper, exposed bumper, cowl screen; decklid, suspension and steering systems, transmission system, air conditioning system, bearings, hose, charging docks, etc.), 2-10, 2, 4, 6, 8, 10 wheeled vehicles, artificial intelligence components such as hardware, software, training data, collected data, etc recharging ports, or any combination thereof. The recharging devices may be made of and/or covered with weather-resistant and/or weather-proof materials.

In an embodiment of the invention, the wearable(s) may include various light-dimmer settings, variable light intensity settings, and/or any combination thereof for safety.

In an embodiment of the invention, the wearable(s) may include red light to aid the humans to see at night without any animals observing or being aware of the human(s) or being disturbed by the human(s). This animal may be prey during hunting, a pet, a domesticated animal, etc. The light may be either visible or non-visible to humans and animals. The light may be white light or another color, e.g., blue, red, yellow, green, and/or any combination thereof. The lights may be visible to humans for 0-20 miles, such as 0-15 miles, 0-12 miles, 0-11 miles, 0-10.5 miles, 0-10 miles, 0-5 miles, etc. The color (red, blue, yellow, green, etc.) light-glows may be observed from 0 to 100 miles, e.g., 0-100 miles, 0-90 miles, 0-80 miles, 0-70 miles, 0-60 miles, 0-50 miles, 0-40 miles, 0-30 miles, 0-20 miles, 0-10 miles, etc.

In an embodiment of the invention, the wearable(s) may have one or more micro-USB and/or a USB port.

In an invention's embodiment, the wearable(s) may have one or more kill switch to conserve battery charge. The kill switch(es) completely turns off the device such that no energy leaks during off or rest mode.

In an embodiment of the invention, the wearable(s) may integrate with an app/APP.

The wearable(s) may be made of a sewable, transparent, plastic, synthetic, non-synthetic, weather-resistance, and/or weather-proof fabric or clothing materials in an embodiment of the invention.

In an embodiment of the invention, the wearable(s) may be adjustable via straps, Velcro, stretchable, elastics, buckles, buttons, etc. This adjustability adds usability to the wearables by making the wearables more comfortable and adjustable in sizes.

In an embodiment of the invention, the wearable(s) may include the lightest, smallest, or both of materials, technologies, apparatus, devices, smart devices, electrical equipment, microelectronics, electronics, microelectronics, micro-computer, the computer, hardware, software, instruments, machinery, and equipment for the wearer's best comfort.

In an embodiment of the invention, the wearable(s) may include the heaviest materials, technologies, apparatus, devices, smart devices, electrical equipment, microelectronics, electronics, the computer, hardware, software, instruments, machinery, and equipment in one or more places for the wearer's best balance and comfort.

In an embodiment of the invention, the location, size, weight, shape, feel (softness, hardness, etc.) of each piece of equipment in and/or on wearables and non-wearables may enhance the user's comfort ease.

The communication and guidance system may be utilized by hunters, animal-walkers, walkers, animal-runners, runners, animal associated recreation activities, security-worker, hikers, bikers, motorcyclists, scooterists, any one, two, four, six, eight, ten wheeled vehicle-drivers, swimmers, animal water sports, animal water or land training, coast guard, navy personal, fishermen, water sports, divers, rescue swimmers, synchronized divers, ship captain, ship/boat crew, ship/boat passengers, etc.

### DETAILED DESCRIPTION OF THE DRAWINGS

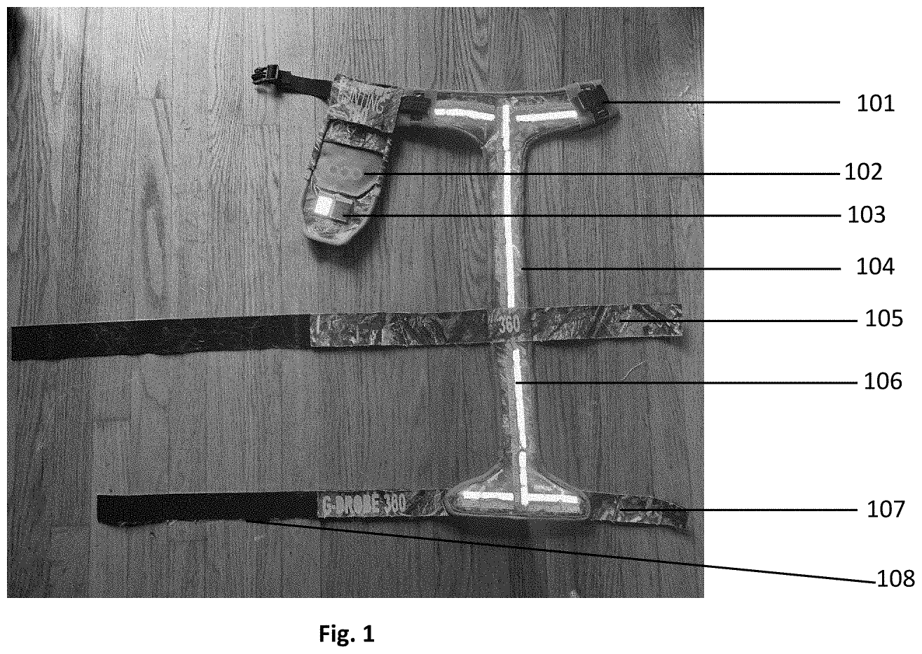

FIG. 1: An aspect of the dog wearable device.

Shown is a wearable device containing four linear strips 101, 104, 105, 107. The first strip 104 is perpendicular (at 90 degrees angle) to the other three strips, the second 101 and the fourth perpendicular strips 107 are attached to the two terminal ends of the first strip 104, the third strip is non-terminal 105, wherein a patch or pouch 102 containing electronics. The electronics and other equipment, apparatus, or devices are contained in a pouch 102 and have two lights (white and red herein) 103. As shown in this figure, the terminal ends of the strips second 101, third 105, and fourth 107 may attach via Velcro, clips, buckle, etc., to form a loop 108. Strip 101 contains one or more light streaks 106. Other strips containing light can be added that are parallel to strip 104 and connect strips 101, 105, and 107 such that additional light can be present on both sides of an animal such as a dog or a cat.

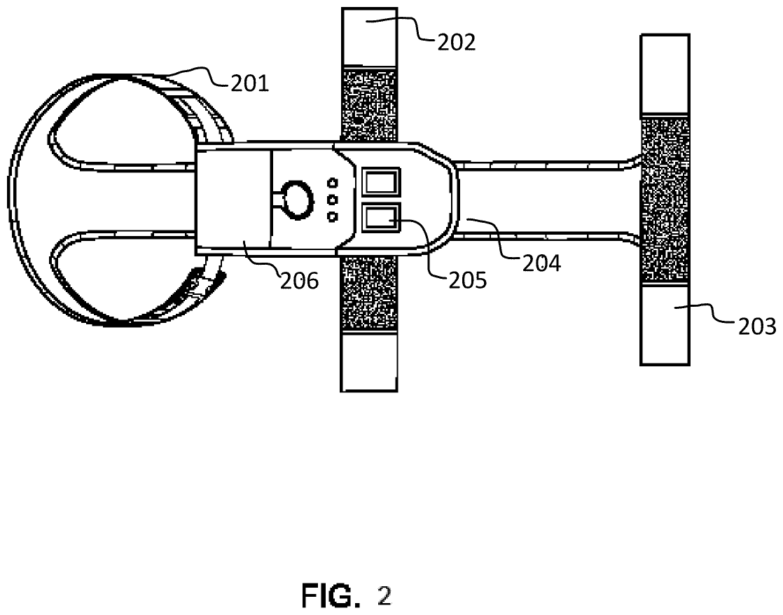

FIG. 2: An aspect of the wearable device showing technologies containing pouch:

This figure shows a wearable device pouch 206 containing four linear strips 201-204. The first strip is perpendicular 204 to the other three strips. The second 201 and the fourth perpendicular strip 203 are attached to the two terminal ends of the first strip 204. The third strip is non-terminal 202, wherein a patch or pouch 206 having electronics and is weather-resistant. The pouch connects the first 204, second 201, and third strips 203 and sits at the most convenient and comfortable place on the dog's neck. This pouch can be placed at other locations on the dog, such as below the dog's belly, neck, etc. Two light bulbs 205 direct the light to shine light into the sky, one light is white, and the other is red. These can be replaced with different light colors. The technologies may be apparatus, devices, smart devices, electrical equipment, microelectronics, electronics, computer, hardware, software, instruments, machinery, and equipment.

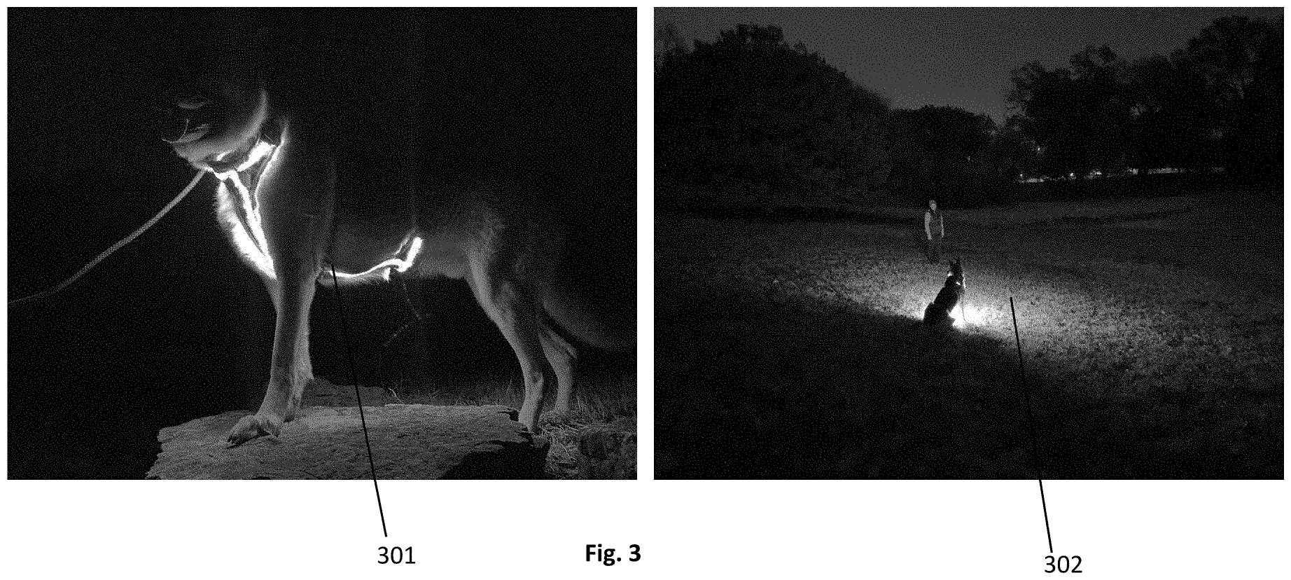

FIG. 3: An aspect of the device worn by a dog:

Shown in this figure is the light streak at the bottom or belly of the dog 301. The intensity of the light streak makes grounds around the dog visible during darkness 302. This visible area can have a diameter of 5 to 50 feet.

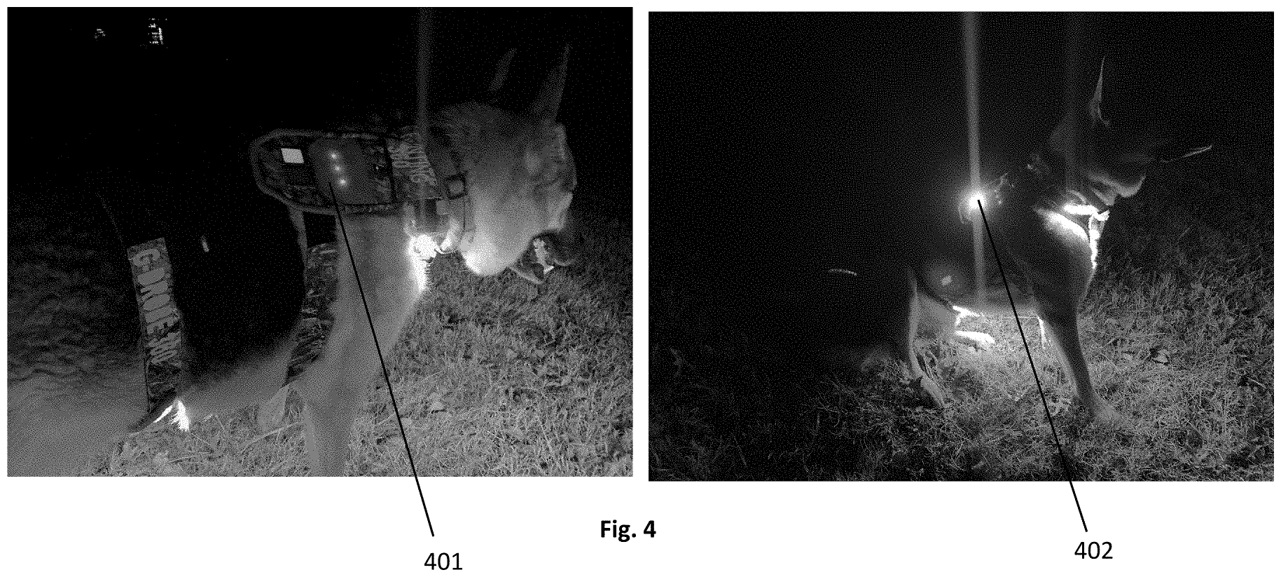

FIG. 4: An aspect of the wearable device showing technologies containing pouch on a dog:

Show in this figure is a wearable electronic device containing a pouch on a dog. Herein the entire wearable and the electronic device pouch are very lightweight. The pouch is placed comfortably on the dog's neck 401. The pouch can also contain lights that can be white or colored 402. The weight of the pouch can be from 0.5 to 10 pounds. Technologies may be apparatus, devices, smart devices, electrical equipment, microelectronics, electronics, computer, hardware, software, instruments, machinery, and equipment.

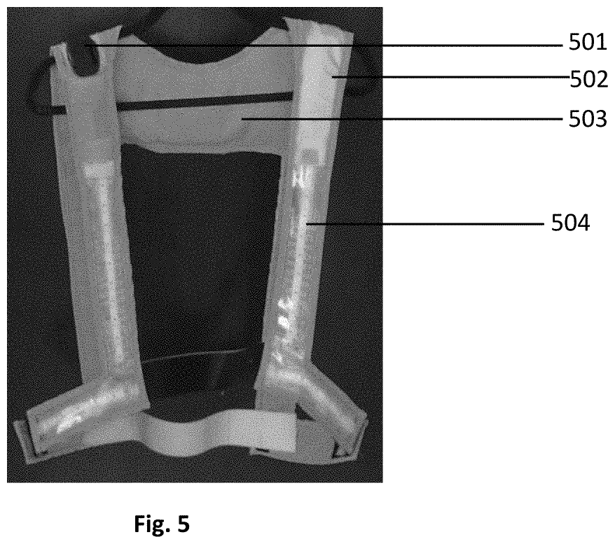

FIG. 5: An aspect of the wearable device worn by a human:

Shown in this figure is a human wearable with the same functions as the aforementioned dog wearable. This wearable can be worn over shoulders or can be attached to any sized backpack. Herein, microphone, speakers are present on the shoulder 501. The earpiece (speakers) and microphone that can be attached to the earpiece are not shown herein. Electronics, microelectronics, electricals, devices, rechargeable batteries, etc., are placed on the shoulder strap and back of the neck for comfort with optimum balance 502 and 503. The straps are adjustable for ease of wear. The weight of the electronics, microelectronics, electricals, devices, etc., can be from 0.5 to 10 pounds. One or more light streaks light the same as the aforementioned dog wearable are present in each strap 504. These lights can also be used as a turn signal function and have various strobe settings and brightness settings for safety utility. The fabric used for this wearable is a sewing machine compatible and transparent plastic fabric.

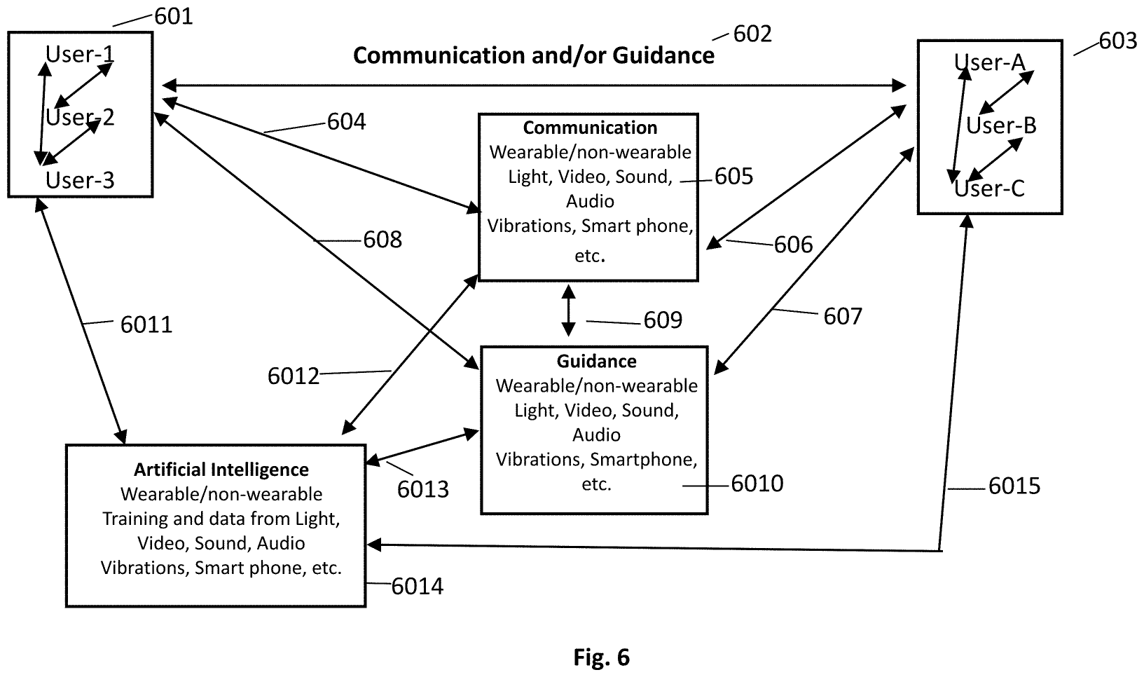

FIG. 6: Integration of wearables and non-wearables for humans and non-human animals.

Shown here is communication and guidance between two groups of users, where the first group is users 1, 2, and 3, 601, and the second user group of users A, B, and C, 603. The communication and guidance may be between the two groups 602 or within each group 601, 603. One group may be humans, e.g., hunters and the other group may be animals, e.g., dogs. The communication and guidance may be direct without the use of any wearables or non-wearable 602. Communication and guidance may be indirect via wearable and/or non-wearables of the invention 604, 605, 606, 608, 6010, 607. Communication and guidance may be automatic via artificial intelligence 6011, 6014, 6015, 6012, 6013, or manual by the user 604, 605, 606, 608, 6010, 607. The user's manual control or operation may supersede automatic control or operation via artificial intelligence 6011, 6014, 6015, 6012, 6013. Wearable and/or non-wearable may have one or more (at least one) devices, technologies, etc. connected such as speaker, microphone, the smart or cellular phone, the camera, video, electrical lights streaks of one or more colors, LED bulbs, flashlight, lantern, vibrating modules, sound generating devices, recharging ports, vehicles, vehicle parts (e.g., staring-wheel, handle-bar, brakes, lights, electronic systems, electrical systems, sensors, floor components car seat, powertrain and chassis, braking system, electrified powertrain components, engine components, engine cooling system, engine oil systems, headlights, bumper cover, car fender, radiator support, catalytic converter, car mirror, car hood, step bumper, lower control arm, tail light, window regulator, fuel pump replacement, car body and main part body components, including trim, bonnet/hood, bonnet/hood, bumper, unexposed bumper, exposed bumper, cowl screen; decklid, suspension and steering systems, transmission system, air conditioning system, bearings, hose, charging docks, etc.), 2-10, 2, 4, 6, 8, 10 wheeled vehicles, artificial intelligence hardware, software, training data, collected data, etc., or any combination thereof 605, 6010. These electronics or devices may be used for communication alone and/or guidance. These wearable and/or non-wearable linked devices or technologies may be further connected or linked to an artificial module, which may include hardware, software, training data, collected data, speaker, microphone, the smart or cellular phone, the camera, video, electrical lights streaks of one or more colors, LED bulbs, flashlight, lantern, vibrating modules, sound generating devices, recharging ports, vehicles, vehicle parts (e.g., staring-wheel, handle-bar, brakes, lights, electronic systems, electrical systems, sensors, floor components car seat, powertrain and chassis, braking system, electrified powertrain components, engine components, engine cooling system, engine oil systems, headlights, bumper cover, car fender, radiator support, catalytic converter, car mirror, car hood, step bumper, lower control arm, tail light, window regulator, fuel pump replacement, car body and main part body components, including trim, bonnet/hood, bonnet/hood, bumper, unexposed bumper, exposed bumper, cowl screen; decklid, suspension and steering systems, transmission system, air conditioning system, bearings, hose, charging docks, etc.), etc. 6014. Information gathered from these devices and technologies may be used by artificial intelligence data collecting software and data storage units combined with or without the training data to communicate and/or guide human and/or animal users. Human users may use a controller or other devices such as smartphones, voice commands, touch-sensitive technologies, etc., to communicate and guide other human and animal users. Animal users may be taught to control the system functions by placing a control button(s) in a convenient location such that the aminal may turn ON/OFF by use of paws, mouth, shoulder, legs, tail, etc. The animal user may then be able to communicate and guide other animal and/or human users.

A method of wearable manufacturing includes backing synthetic or non-synthetic materials such as, but not limited to, cotton, silk, wool, linen, nylon, spandex, rayon, polyester, acrylic, natural leather, artificial leather, etc. Electronics are attached to this backing material via a variety of methods such as, but not limited to, adhesive, heat-adhesives, sewing, non-sewing, snap-on, glue, zippers, buckles, etc., or any combination thereof. The electronics are then covered with transparent, translucent, or opaque materials depending upon requirements for visibility. The backing materials and electronic material covering materials are either weather-resistant and/or -proof and/or they are covered with weather-resistant or -proof material, or any combination thereof. Machine, equipment, devices, etc., in this manufacturing can be unique and novel for the purposes of manufacturing these wearables and/or non-wearables.

An example of an embodiment:

A communication and guidance integration system may be made up of the integrated devices on animals and humans. The animal may be a hunting dog wearing a wearable made-up of four linear strips, wherein the first strip may be perpendicular to the other three strips, the second and the fourth perpendicular strip may be attached to the two terminal ends of the first strip, the third strip may be non-terminal, wherein the patch or pouch containing electronics may connect first, second, and third strips. Light streaks of different color lights such as white, blue, green, red, or any combination of colored lights may be attached, mounted, and/or sewed to first, second, third strips, or any combination thereof. The first strip may place beneath the dog such that lights illuminate the grounds around the dog. Fourth and fifth strips may attach parallel to the said first strip such that the additional fourth and fifth strips may place on each side of the dog to illuminate the dog's surroundings better.

The patch containing the electronic devices may be balanced and comfortable for the dog. The patch or pouch includes a variety of wired or cabled, wireless, or both devices. The patch or pouch may contain electronic, micro-electronic, electrical, computerized, smart, etc. such as a speaker, microphone, the cellular phone, the camera, electrical lights, LED bulbs, flashlight, a lantern, USB port, micro-USB port, vibrating modules, sound generation device, recharging ports, artificial intelligence components such as hardware, software, training data, collected data, etc., and/or any combination thereof. The recharging devices may be made of and/or covered with weather-resistant and/or weather-proof materials. The light and vibrating devices and components (electrical, electronics, microelectronics, computer, and others) may be present in or on one or more strips. The dog may or may not have a leash.

The human may be a hunter, wherein the hunter may be behind the dog. The communication may be at least uni-, bi-directional, i.e., from the human to the dog, dog to human, or both. However, communication may be multi-directional when communication is between several hunters and dogs.

Lights on the dog may guide the hunter(s) as they seek and search in the dark for their prey. Thus the lights on the dog function as a flashlight or a lantern. The red light is not visible to most animals, so when the red is on-mode, red light aids the hunter in prey hunting without frightening off the prey. The human hunter can see in the red light; thus, hunters see the grounds and target prey.

The human hunter may communicate with other human and animal (dog) hunters via various methods and apparatus. The hunter may talk to the dog over the speaker system or send a vibrational signal, which may be located for the dog's best hearing, comfort, and tactile feel. The device is very lightweight for the comfort and convenience of the animal and without hindering the animal's movement.

Users may utilize lights and different visibility units for communication and guidance. Different light visibility units, colors, intensity, strobing, etc., may be used for communication and guidance. For example, the enhanced visibility units on the front side may output one color (e.g., white, clear, yellow, green, etc.). In contrast, the visibility units on the backside may output another color (e.g., red, blue, etc.).

Both wearables and non-wearables may attach to human and animal garments such as but not limited to, vest, life-vest, outer-wear, out-protective wear, harness, shirt, T-shirt, jacket, coat, harness, pants, dress, footwears, shoes, etc. Both wearables and non-wearables may attach to other human and animal devices and accessories such as, but not limited to, a backpack, belt, jewelry, vest, life-vest, harness, jacket, coat, pants, collar, etc.

The hunter communicates and guides by using the vibrating modules present at various locations on dog wearables. The dog may be previously taught regarding the meaning of each vibration with different strobing, intensity, locations, and any combination thereof. Hence, the human hunter may use lighting, vibrations, voice, etc., to communicate and guide the dog. One or more but less than 20 vibrating modules may be placed on the dog device, and each device may have one or more (but less than 20) strobing and intensity of the vibration. Each setting of the vibration pulse or beats may be taught to the dog (or another animal) to indicate a specific command such as the vibration of the left module or a particular number of vibrational beats signals “turn left” or vibration of the right module or different intensity of vibrations signals “turn right” or strobing vibration of the module signals “bring the prey to the hunter,” etc. The vibration intensity is gentle without pain, discomfort, or harm to the dog or animals. Similarly, vibrations may be used to communicate and guide between humans or between humans and animals. Lights may replace vibrations to communicate and guidance between humans and/or between humans and animals.

Lights may be used as diodes/LEDs single or combined (spotlight, COB light, turn signal, visibility-enhancing system, etc.). The diode/LEDs as single or combined may have the lumens of 10 to greater than 2000, e.g., 10-20, 20-150, 150-160, 160-200, 200-500, 500-600, 600-1000, 1000-1200, 1200-1500, or 1500-2000, etc. The user's visibility may be higher than 100 meters, e.g., up to 100 meters, up to 120 meters, up to 250 meters, up to 300 meters, up to 400 meters, up to 500 meters higher than 500 meters. The communication and guidance may use a light device (106, spotlight 130, COB light 128, etc.) at an angle such that they may not blind the user or onlookers but may make the grounds or skies visible. The light angles may be adjustable via strips, extension clips, or other strips. The user may control the angle of the beam of light hitting grounds as a narrow or broad beam for maximum communication, guidance, and visibility.

Lights may communicate and guide turn signal features incorporated in the LED (or other lights) on wearables and non-wearables. The lights may be controlled by a mobile APP to manage all of the features of the device via a software application program (an APP), voice-activated/recognition, or touch-sensitive technologies, electrical button on the device, control panel buttons, the user interface device, secondary controller, etc.

Besides the lights system for guidance, the hunter can use cameras mounted on the dog with 0-360 degrees rotations, e.g., 0-15, 0-30, 0-45, 0-65, 0-90, 0-105, 0-125, 0-140, 0-180, 0-200, 0-215, 0-230, 0-245, 0-290, 0-305, 0-320, 0-335, 0-350, 0-360 degrees, and extendable up from 0-5 feet, e.g., 0-0.5, 0-1, 0-1.5, 0-2, 0-2.5, 0-3, 0-3.5, 0-4, 0-4.5, 0-5 feet.

Furthermore, using similar or the same wearable and non-wearable devices, the hunter, may communicate with other hunters individually or as a team. The lights on the dog's wearable may be used to communicate and guide other hunters, humans, and animals. The communication and guidance may be between one or more dogs, one or more hunters, or any combination of a dog(s) and hunter(s); other animals such as, but not limited to, cats, horse, elephant, cow, buffalo, bull, rat, mice, rabbit, bear, cattle, sheep, chicken, cock, whales, dolphins, penguins, etc.

The hunter(s) can also track a lost dog(s) or another animal. Animals or dogs(s) that may not be visible may be tracked via a variety of methods and apparatus such as micro-GPS/SOS tracking device, sound system (animal's sound through a microphone and/or sound generated by a device on the dog wearable/non-wearable), etc. There may be situations where the dog light towards the grounds may become invisible to the hunter, but the top light directed towards the sky on a dog may help track the dog. In the same manner, lost hunter(s) may be searched by other hunters or search teams if one or more hunters become lost.

The hunter may use wired or wireless devices to communicated and guide dogs or other hunters and rescue teams. The hunter may use a voice command system, touch-sensitive systems, wired or wireless networks (remote-control) to activate wearable and non-wearable devices. For example, a hunter may use voice-command to start a cellular phone and then may use voice google maps for directions. Similarly, a hunter may get a voice or visual information regarding prey, animal, etc., in real-time to make the hunting experience more efficient. During an emergency, the hunter(s) can obtain vital information from google, etc., for survival, contact, communicate, and guide search and rescue teams. Control and/or ON/OFF switches may be in convenient locations such as in and around the shoulder area, areas coving anterior of a person, hands, arms, etc.

Wearable or non-wearable may integrate technologies for vital measurements such as sensors, etc. Hunters and others may monitor the vitals of themselves, other humans, and animals. The vital may include body heat or temperature, heart rate, blood pressure, EKG, etc.

The one or more batteries for powering the communication and guidance system may include any suitable type of battery. For example, one or more batteries may include multiple rechargeable batteries. In one example, the battery is a rechargeable 3s lithium-ion battery. These rechargeable batteries may power communication, guidance, and controller for about sixteen hours. In such examples, the device may include a charging port for receiving a charger. A user may charge/recharge the rechargeable batteries by plugging the charger into the charging port and a power source. In some examples, the charger may include a visual or auditory indicator to notify the user that the charger is electrically connected to the charging port. The battery may be placed strategically at any location on the device, for example, on the backside below the neck and along the middle of the two shoulders of humans and animals.

For example, the device may include one battery, two batteries, three, four batteries, more or less than four batteries, five, six, seven, eight, nine, or ten batteries, more or less than ten batteries, etc. The number of batteries may depend on, for example, the amount of power required by the devices of communication and guidance system, the controller, and/or other electronic components.

The kill switch may turn the system entirely or almost entirely off by various methods such as directly turning off a button, by touch-sensitive or voice command turn off systems. The kill switch system ensures the most efficient use of battery and extended battery life for emergencies.

This system provides for communication and guidance via various methods and apparatus such that the system may use visual signal, sound, and touch-sensitive devices and methods. All uses may optimize the utility of the system depending upon their ability to read, listen, etc., to the information. Therefore, the system may have a hands-free effect via solely touch-sensitive and voice commands. Hence, the user may enhance the system's versatility for a variety of situations and locations. In this example, the hunter may be replaced by many others requiring such communication and guidance system. Many other animals may replace the dog, such as but not limited to pets, zoo animals, animals in the wild, domesticated animals, cats, horse, elephant, cow, buffalo, bull, rat, mice, rabbit, bear, cattle, sheep, chicken, cock, whales, dolphins, penguins, etc.

The controller may include an enclosure for housing one or more circuit boards (e.g., printed circuit boards, micro-circuit boards, etc.) and a user interface device. The user interface device receives user input and provides one or more signals to the enclosure. The enclosure includes circuitry (e.g., electronic components, micro-electronic components, cable, traces, artificial intelligence components such as hardware, software, training data, collected data, etc.) for controlling the communication and guidance response to user input provided by the user interface device. The enclosure includes one or more outputs for coupling to the communication and guidance units or devices. The outputs may be cables (e.g., conductors, etc.) extending between the enclosure and the communication and guidance units. The cables, micro-cables may be woven into the materials of the wearables. They may transmit one or more signals (e.g., power signals) to the enhanced communication and guidance for control purposes. The enclosure may include one or more enhanced visibility detecting sensors or microsensors connected or coupled (via cables or wirelessly via Bluetooth, micro-wireless, internet of things, etc.) to a processor, microprocessor and/or other artificial intelligence components. The artificial intelligent module or components (software and hardware such as processor, microprocessor, wireless, micro-wireless, etc.) may be coupled to the controller, which (controller) may communicate or be coupled to the user interface.

The device may contain communication- and guidance-detecting sensors (or microsensors), which may be coupled and connected to a processor or microprocessor and artificial intelligence module and components (software, hardware, data). User data collected from the device and systems, data training, or any combination of both may teach the artificial intelligence software to control the communication and functions. For example, in some particular situations, the artificial intelligence may turn on lights or vibration modes at the front side and not at the backside of the device/user/system or dim the light units in the backside but not at the front side of the device. The artificial intelligence may control all other functions of the communication and guidance units such as color, strobing, intensity, and other device functions mentioned herein, including video and stationary cameras, etc. The user may have similar capabilities to control and operate the communication and guidance units, intensity, color, strobing, cameras, etc. via an APP on the phone screen, voice-activated/recognition, or touch-sensitive technologies, electrical button on the device, control panel buttons, the user interface device, secondary controller, etc. User control may supersede artificial intelligence control if a user implements differently compared to artificial intelligence.

It is to be understood that the above description is intended to be illustrative and not restrictive. For example, the above-described embodiments (and/or aspects thereof) may be used in combination with each other. In addition, many modifications may be made to adapt a particular situation, method, system device, or material to the teachings of the various embodiments of the invention without departing from their scope. While the particulars and details described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims and may include other examples that occur to those skilled in the art. Such other examples are intended to be within the scope of the claims if the examples have structural elements or steps that do not differ from the literal language of the claims or if the examples include equivalent structural elements or steps with insubstantial differences from the literal language of the claims.

We claim:

1. A communication and guidance integration system comprising the integration of the devices on animals and humans, wherein at least one device is wearable.

2. The system of claim 1, wherein at least one device is a non-wearables; wherein the non-wearable device is selected from the group consisting of cameras, smartphones, speakers, microphones, and vehicles.

3. The wearable of claim 1, wherein the human wearable is selected from the group consisting of human clothing, a vest, jacket, legwear, pants, headwear, neckwear, socks, shoes, footwear, and jewelry.

4. The system of claim 1, wherein the system communicates wirelessly.

5. The system of claim 1, wherein the system can be activated and operated by touch-sensitive technology.

6. The system of claim 1, wherein the system can be activated and operated by voice command technology.

7. The system of claim 1, wherein the batteries can be recharged wirelessly.

8. The system of claim 1, wherein the batteries can be recharged by solar energy.

9. The system of claim 1, wherein the system is integrated with at least one tracking device selected from the group consisting of micro-GPS/SOS, sound-generating tracking, and light-generating signals.

10. The system of claim 1, wherein the system is weather-resistant, water-resistant, temperature-resistant, humidity-resistant, weather-proof, water-proof, temperature-proof, and humidity-proof.

11. The system of claim 1, wherein the system further comprises of one or more electronic devices selected from the group consisting of a speaker, microphone, the cellular phone, the camera, video camera, smartphone, electrical lights streaks of one or more colors, LED bulbs, flashlight, lantern, vibrating modules, sound generating devices, recharging ports, USB port, and micro-USB port.

12. The system of claim 1, wherein the communication and guidance is via the light system, wherein at least one light system is selected from the group consisting of strobe light mode, light color modes, and light brightness modes.

13. The system of claim 1, wherein the system has at least one kill switch to conserve battery energy.

14. The system of claim 1, wherein the system is integrated with a software APP.

15. The system of claim 1, wherein the animal wearable further comprising of four linear strips, wherein first strip is perpendicular to the other three strips, the second and the fourth perpendicular strip are attached to the two terminal ends of the first strip, the third strip is non-terminal, wherein a patch containing electronics connects first, second, and third strips; wherein the terminal ends of the said strips second, third, and fourth can be attached to form a loop.

16. The wearable of claim 16, wherein the first strip contains at least one light streaks;
wherein the light steaks can be selected from the group consisting of white, red, blue, yellow, and any combination thereof.

17. The system of claim 1, wherein the electronic can be controlled by one or more selected from the group consisting of remote control, pet wearable, pet reins, and pet leash.

18. The system of claim 1, wherein the system for communication and guidance is operated and regulated by artificial intelligence.

19. The system of claim 1, wherein the system is used for communication and guidance between one or more human users.

20. The system of claim 1, wherein the system is used for communication and guidance between one or more human users and at least one animal, wherein the animal is selected from the group consisting of pets, hunting animals, zoo animals, animals in the wild, domesticated animals, dogs, cats, horse, elephant, cow, buffalo, bull, rat, mice, rabbit, cattle, sheep, chicken, cock, whales, dolphins, penguins, ferrets, bovine, pigs, rodents, hamsters, gerbils, chinchillas, rats, and Guinean pigs.
